(19) United States
(12) Patent Application Publication
(10) Pub. No.: US 2002/0164129 A1
(43) Pub. Date: Nov. 7, 2002

(54) Optical fiber passive alignment fixture

(76) Inventor: Michael K. Jackson, Richmond (CA)

Correspondence Address: Dean A. Pelletier, McAndrews, Held & Malloy, Ltd., 34th Floor, 500 West Madison Street, Chicago, IL, 60661, US

(21) Appl. No.: 10/116,079

(22) Filed: Apr. 4, 2002

Related U.S. Application Data
(60) Provisional application No. 60/281,650, filed on Apr. 5, 2001.

(51) Int. Cl. G02B 6/26; G02B 6/30

(52) U.S. Cl. 385/52; 385/49

(57) ABSTRACT

This invention is related to the field of integrated optics (that is, integrated photonics). In particular, the present devices are optical fiber passive alignment fixtures that comprise at least two planar or substantially planar fiducial surfaces and that align optical fibers with planar or substantially planar optical (that is, photonic) circuits, and enable effective attachment of the optical fibers to the planar or substantially planar photonic circuits. The alignment and attachment take place with the longitudinal axis of each optical fiber oriented at an angle that is normal, near-normal or off-normal to a plane (that is, the top planar surface) of the planar or substantially planar photonic circuit.

### CROSS-REFERENCE TO RELATED APPLICATIONS

This application relates to and claims priority benefits from U.S. Provisional Patent Application Serial No. 60/281,650, filed Apr. 5, 2001, which is incorporated by reference herein in its entirety.

### FIELD OF THE INVENTION

This invention is related to the field of integrated optics (that is, integrated photonics). In particular, the present devices are optical fiber passive alignment fixtures that comprise at least two planar or substantially planar fiducial surfaces and that align optical fibers with planar or substantially planar optical (that is, photonic) circuits, and enable effective attachment of the optical fibers to the planar or substantially planar photonic circuits. The alignment and attachment take place with the longitudinal axis of each optical fiber oriented at an angle that is normal, near-normal or off-normal to a plane (that is, the top planar surface) of the planar or substantially planar photonic circuit. A planar or substantially planar photonic circuit comprises at least one optical device (for example, a photonic input/output (I/O) port, laser, photodetector, waveguide or filter).

### BACKGROUND OF THE INVENTION

Effective optical (that is, photonic) telecommunication systems require high-performance, low-cost photonic devices. Such a requirement has motivated development of integrated photonic circuits that are planar or substantially planar. Those circuits interface with other devices and system components using input/output (I/O) ports, which may be referred to as couplers and which typically optically connect planar or substantially planar circuits to cylindrical optical fibers. Such I/O ports can act as input ports, output ports, or bi-directional ports. As used herein, the terms input port(s), output port(s), bi-directional port(s) and I/O port(s) may be used interchangeably. In other words, unless otherwise specified, each of those terms contemplates and includes all of those terms.

In planar or substantially planar photonic circuits, coupling light to or from an optical fiber is commonly achieved in a geometry arrangement using a system of lenses (FIG. 1(a)). Such a system typically requires highly accurate alignment of micro-photonic elements. Furthermore, the tendency for such micro-photonic elements to move (physically) over time, and the cost of assembling those complex systems have motivated others to develop other approaches for coupling light from/to an optical fiber and to/from an optical device (such as a photonic I/O port) in a planar or substantially planar photonic circuit. For example, and as shown in FIG. 1(b), an optical fiber may be directly attached to a planar or substantially planar photonic circuit, with the longitudinal axis of the optical fiber oriented parallel to the plane of the photonic circuit. In the geometrical configuration shown in FIG. 1(b), optical waveguides are formed within the plane of the photonic circuit, and the optical fiber is aligned with (that is, arranged in a desired or effective spatial relationship with) those waveguides. A desired or effective spatial relationship typically contemplates the x, y and z directions. The geometrical configuration shown in FIG. 1(b) is referred to herein as the axial coupling geometry.

Active alignment has previously been used to align optical fiber(s) with planar or substantially planar photonic circuits. Active alignment typically initially involves energizing an optical device (for example, a semiconductor injection laser) within the planar or substantially planar photonic circuit at issue. By then detecting and monitoring a corresponding optical signal that results from the energizing step (for example, by detecting and monitoring optical power coupled into the optical fiber being aligned), it is possible to assess the process and success of the alignment, and to adjust and optimize the alignment between the optical fiber and the photonic circuit. When the corresponding signal is maximized, the optical fiber is then properly aligned and may be fixed in place (for example, with a suitable adhesive). Such active alignment techniques have been extended to optical fiber ribbons (that is, arrangements of several optical fibers within a linear or substantially linear array). Unfortunately, such active alignment schemes add manufacturing costs and complexity, and it is desirable to eliminate such costs and complexity.

Passive alignment techniques, which utilize passive fixtures (that is, structures that, by their mechanical design, are capable of aligning an optical fiber with a planar or substantially planar photonic circuit without requiring adjustments) are typically more preferable than active alignment techniques. One such fixture, which has been described in prior work, is the V-groove, which is illustrated schematically in FIG. 2. As shown in FIG. 2(a), a V-groove may be etched into a structure, with the longitudinal axis of the V-groove oriented in the plane of the planar or substantially planar photonic circuit. Once the V-groove is formed, an optical fiber can then be placed within the V-groove, as illustrated in FIG. 2(b), and that V-groove passively aligns the optical fiber with the photonic circuit. Typically, the optical fiber is aligned such that an effective junction or interface is formed between the optical fiber and an appropriate optical device, such as a photonic I/O port, within the photonic circuit.

Another problem with the above-described approaches to aligning optical fibers with a planar or substantially planar photonic circuit is the difficulty in meeting the need for photonic circuit surfaces of sufficiently high quality (that is, highly smooth, planar or substantially planar surfaces, which may be prepared by cleaving, polishing, and/or etching, and through which a photonic signal may pass). In addition, to be effective, many planar or substantially planar photonic circuits are required to be polarization independent (that is, to operate substantially the same way for any input polarization). Consistently achieving polarization independence in effectively axially coupled planar or substantially planar circuits has proven to be generally difficult and, in some cases, has resulted in I/O ports that compromise a circuit's overall performance or flexibility. Moreover, devices, such as I/O ports, fabricated on the same wafer cannot be properly tested until after separation into individual elements. Such testing constraints have further complicated efforts to commercialize effective telecommunication systems.

The present passive alignment fixtures can be incorporated into planar or substantially planar photonic circuits and be used with otherwise appropriate optical devices, such as photonic I/O ports, to effectively couple light to/from optical fibers. The present passive alignment fixtures align optical fibers oriented at normal, near-normal or off-normal angles with respect to the plane of a photonic circuit, as shown in FIG. 3. As used herein, the term “near-normal” shall mean and include angles that range from approximately −30° to approximately +30°, as measured from the normal to the plane of a planar or substantially planar photonic circuit to the longitudinal axis of an optical fiber. The term “off-normal” shall mean and include all “near-normal” angles except those angles equal to approximately 0°.

The present passive alignment fixtures achieve effective and precise alignment of an optical fiber with, and attachment of an optical fiber to, a planar or substantially planar photonic circuit, or an optical device(s), such as a photonic I/O port, within the planar or substantially planar photonic circuit, and by that effective and precise alignment and attachment, realize effective coupling of light within the planar or substantially planar photonic circuit or at the junction between the optical fiber and the optical device.

### BRIEF DESCRIPTION OF THE DRAWINGS

FIG. 1 is a schematic diagram showing conventional axial geometry for coupling light into a planar photonic waveguide by (a) a system of lenses and (b) by direct attachment of an optical fiber to a photonic circuit.

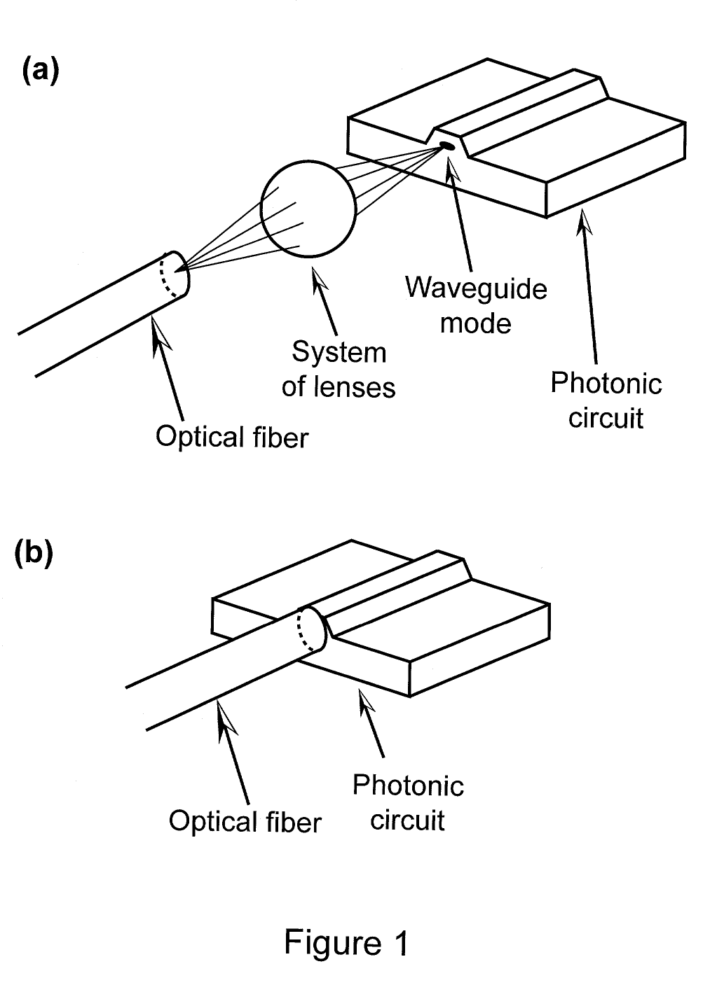

FIG. 2 is a schematic diagram of a prior silicon V-groove passive alignment structure for conventional axial geometry, showing (a) a V-groove after etching, (b) an optical fiber placed into the V-groove.

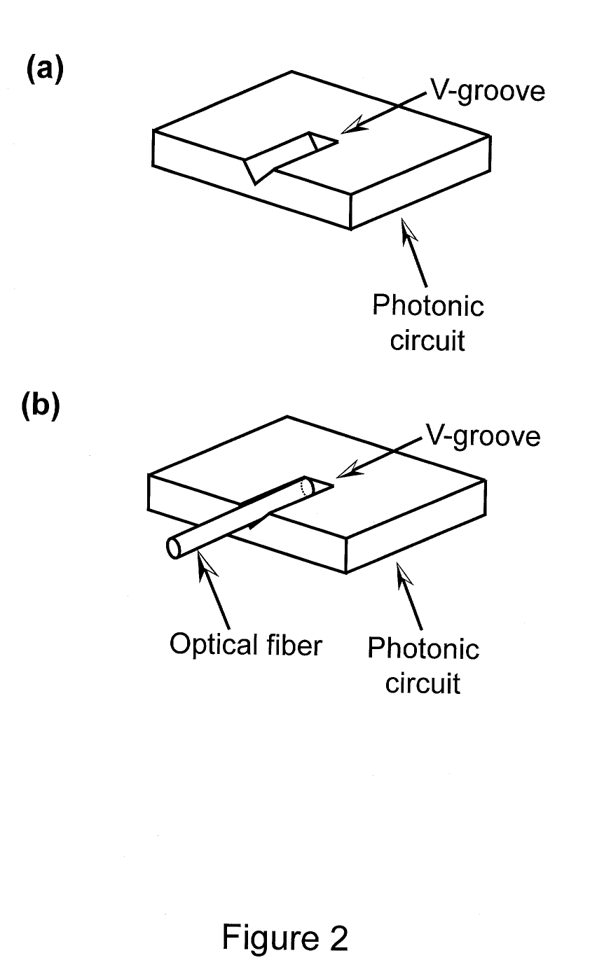

FIG. 3 is a schematic diagram showing direct optical fiber attachment to a photonic circuit, with the fiber oriented at a near-normal angle with respect to the plane of the photonic circuit.

FIG. 4 shows schematic layouts of the optically active portion of representative I/O ports, which are suitable for (a) coupling light of a known polarization, and (b) coupling light of an unknown or varying polarization.

FIG. 5 shows a cross-sectional view of layers comprising a representative I/O port.

FIG. 6 shows a plan view schematic of a present passive alignment fixture for one optical fiber oriented at normal incidence to the plane of a photonic circuit.

FIG. 7 shows a cross-sectional schematic view along plane VII-VII′ of FIG. 6.

FIG. 8 show a plan view schematic of a present passive alignment fixture for one optical fiber oriented at an off-normal angle relative to the plane of a photonic circuit.

FIG. 9 shows a cross-sectional schematic view along plane IX-IX′ of FIG. 8.

FIG. 10 shows a plan view schematic of present passive alignment fixtures for two optical fibers oriented at an off-normal angle relative to the plane of a photonic circuit.

FIG. 11 shows an assembly procedure to attach an optical fiber at off-normal incidence to an I/O port, showing (a) an initial position, with the optical fiber not touching a photonic circuit or either of two alignment posts, (b) an intermediate position, with the optical fiber touching at least two contact points on the two alignment posts, and (c) a final position, with the optical fiber touching the two alignments posts and the photonic circuit.

### SUMMARY OF THE INVENTION

The present optical fiber passive alignment fixtures comprise at least two planar or substantially planar fiducial surfaces, achieve effective and precise alignment of optical fibers with planar or substantially planar photonic circuits and enable effective attachment of the optical fibers to the planar or substantially planar photonic circuits. The present passive alignment fixtures can be effectively used with the longitudinal axis of each optical fiber oriented at an angle that is normal, near-normal (that is, within approximately 30° of normal) or off-normal to a plane (that is, the top planar surface) of the planar or substantially planar photonic circuit. Preferably, the longitudinal axis of each optical fiber is oriented at an angle approximately 8° from the normal to the plane of the photonic circuit. The present passive alignment fixtures may be fabricated by micro-machining techniques on a surface of a planar or substantially planar photonic circuit. The at least two planar or substantially planar fiducial surfaces are normal or substantially normal to the plane of a planar or substantially planar photonic circuit. The at least two planar or substantially planar fiducial surfaces are formed by and are at least two planar or substantially planar surfaces of at least two alignment posts, which are located on the photonic circuit.

### DETAILED DESCRIPTION OF PREFERRED EMBODIMENTS(S)

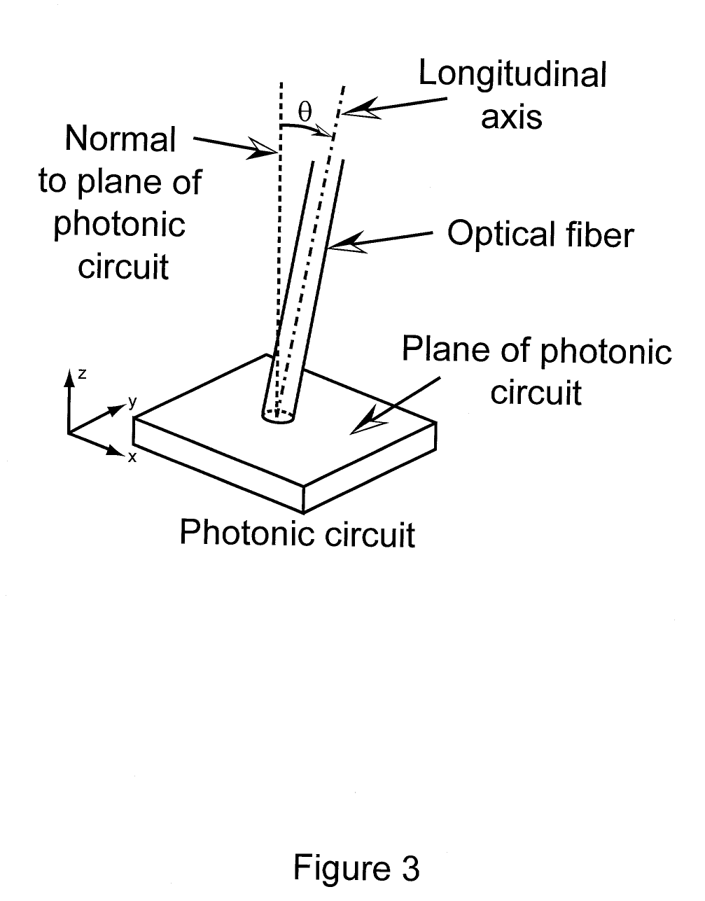

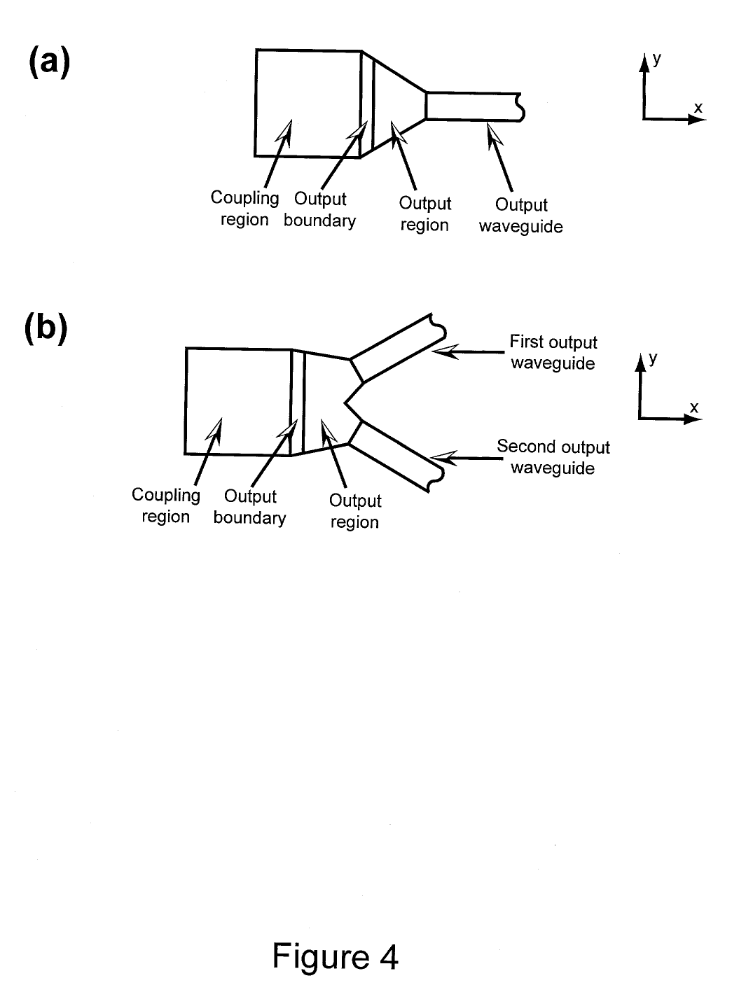

In FIG. 3, an optical fiber is oriented at an angle, θ, from the normal of the plane of a planar or substantially planar photonic circuit, and the optical fiber is then aligned with the photonic circuit (for example, aligned with an optical device, such as a photonic I/O port within the photonic circuit). The present passive alignment fixtures can be effectively used with photonic I/O ports of the type described and claimed in U.S. patent application Ser. No. ______, which was filed on Mar. 28, 2002 and is incorporated by reference herein in its entirety. Terms that are used in that U.S. Patent Application and this application shall be defined as set forth in that Application, unless otherwise specified herein. The I/O ports described and claimed in U.S. patent application Ser. No. ______, which was filed on Mar. 28, 2002, may be manufactured with lithographic patterning techniques. More specifically, such techniques may be used to manufacture an I/O port comprising an optical coupling region, at least one output region and at least one output waveguide. Representative schematic configurations of such an I/O port are shown in FIGS. 4(a) and (b). The photonic I/O port shown in FIG. 4(a) is suitable for coupling light of a known or fixed polarization, and the I/O port shown in FIG. 4(b) is suitable for coupling light of an unknown or varying polarization. As used herein, an optically active portion of an I/O port comprises a coupling region (which further comprises at least one optical scattering element), an output boundary and at least one output waveguide. Such optical functions are not of direct concern to the present passive alignment fixtures. However, the present passive alignment fixtures align an optical fiber with an optical device, which, by way of example, can be the optically active region of a photonic I/O port.

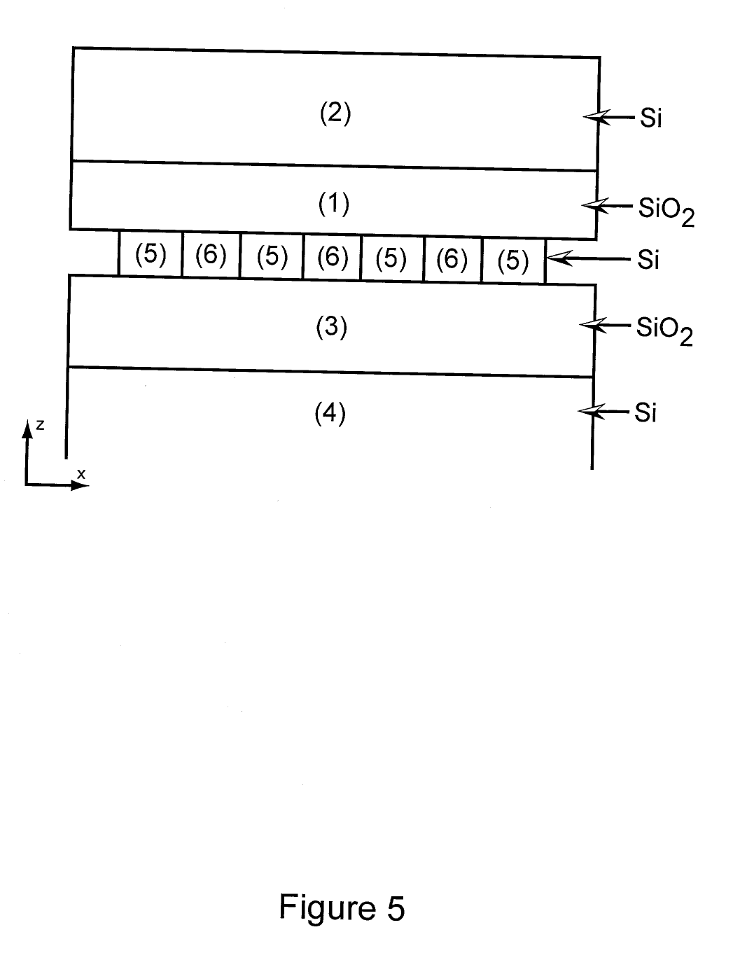

In an embodiment of the photonic I/O ports of U.S. patent application Ser. No. ______, which was filed on Mar. 28, 2002, a layer structure comprising an SiO₂ layer and a relatively thick Si layer may, for example, be wafer bonded to a planar or substantially planar photonic circuit on which the optically active portion of an I/O port has been patterned. FIG. 5 shows a cross-sectional view of such a resulting structure, which may comprise unpatterned superstrate layers (1, 2), which may comprise SiO₂ (silicon dioxide) and Si (silicon), respectively, substrate layers (3, 4) which may comprise SiO₂ and Si, respectively, and an intermediate layer (5), which may comprise Si. The unpatterned superstrate layers (1, 2) serve as mechanical protection by encapsulating optical scattering elements (5) that are patterned within and a part of the optically active portion of the I/O port. Such an embodiment an I/O port may provide certain commercial advantages not related to actual performance of the I/O port. For example, packaging of the above-described embodiment of the present I/O ports may be facilitated insofar as packaging materials may come into contact with the upper surface of the finished device without any concern for damage to the finished device. Further, such an embodiment of an I/O port may prevent particulates and other undesirable by-products of chip dicing and manufacturing from becoming embedded in the patterned optical scattering elements (for example, when the optical scattering elements are filled with air, vacuum, or a gas).

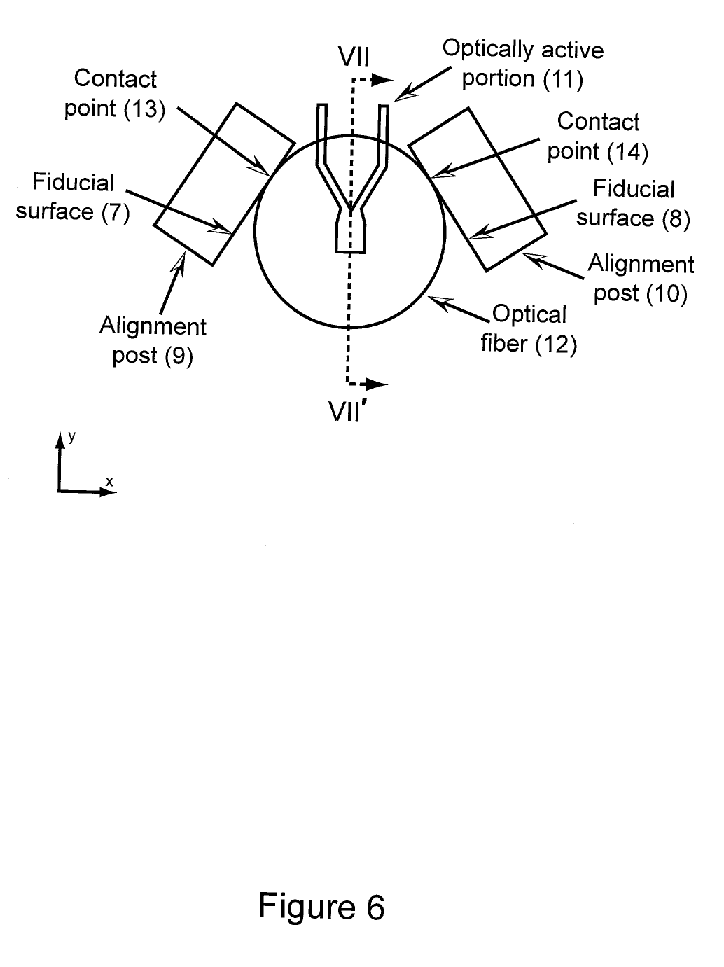

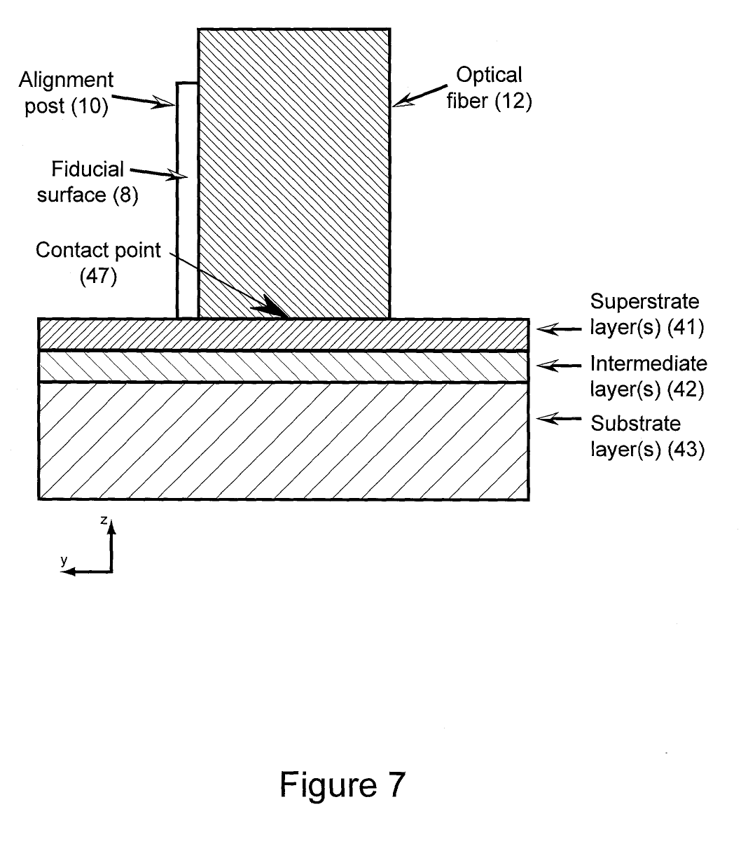

The I/O port of FIG. 5 may then be patterned by micro-machining techniques (for example, optical lithography, dry etching, anisotropic wet etching, selective etching, electroplating, deposition, deep reactive ion etching and/or selective area epitaxy) to form a passive alignment fixture comprising at least two planar or substantially planar fiducial surfaces, which can align an optical fiber with its longitudinal axis at an angle that is normal, near-normal or off-normal to the plane of a planar or substantially planar photonic circuit. FIG. 6 shows such a passive alignment fixture. In the embodiment of the present passive alignment fixture shown in FIG. 6, the two fiducial surfaces (7, 8) are formed by and are two planar or substantially planar surfaces of two alignment posts (9, 10). The two fiducial surfaces (7, 8) are positioned at an appropriate distance (or appropriate respective distances) from the optically active portion (11) of the I/O port. As shown in FIG. 6, in-plane alignment (that is, alignment in the x-y plane) of an optical fiber (12) is achieved by contact of the optical fiber (12) with at least two points (13, 14) on the planar or substantially planar surfaces (that is, the two fiducial surfaces (7, 8)) of the two alignment posts (9, 10). The two fiducial surfaces (7, 8) are normal or substantially normal to the plane of the planar or substantially planar photonic circuit. FIG. 7 shows a cross-sectional view of the passive alignment fixture of FIG. 6, which fixture has been cut through plane VII-VII′ of FIG. 6. FIG. 7 further shows a suitable superstrate layer(s) (41), a suitable intermediate layer(s) (42) and a suitable substrate layer(s) (43) for a photonic I/O port of U.S. patent application Ser. No. ______, which was filed on Mar. 28, 2002. As shown in FIG. 7, vertical alignment of the optical fiber (12) (that is, alignment in the z direction) is achieved by contact of the optical fiber (12) with at least one additional point (47) on the superstrate layer(s) (41) of the photonic I/O port. A suitable in-plane angle between the two fiducial surfaces (7, 8) is approximately 90°, but such an angle may properly range from approximately 30° to approximately 150°. It may be advantageous, in certain applications, to form the two fiducial surfaces (7, 8) on separate alignment posts, as shown in FIG. 6, (thereby potentially facilitating design and/or manufacture of the photonic circuit), or on a single alignment post (for example, an L-shaped assignment post or a chevron-shaped alignment post).

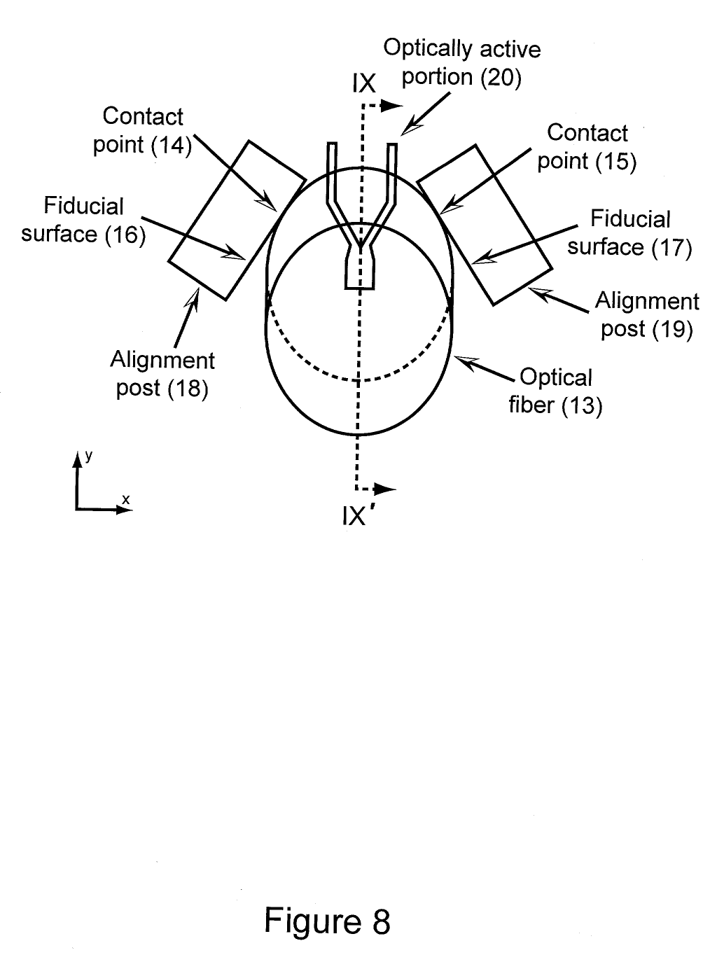

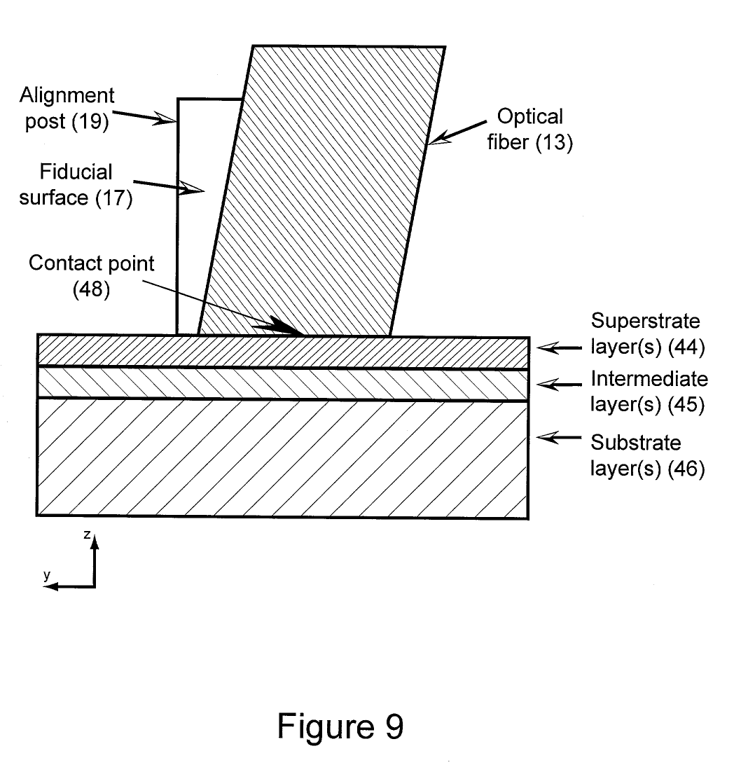

In another preferred embodiment of the present passive alignment fixtures, an optical fiber is oriented with its longitudinal axis off-normal to the plane of the planar or substantially planar photonic circuit, and preferably approximately 8° away from the normal to the plane of the photonic circuit. Such an embodiment is shown in FIG. 8, wherein in-plane alignment (that is, alignment in the x-y plane) of an optical fiber (13) is achieved by contact of the optical fiber (13) with at least two points (14, 15) on two fiducial surfaces (16, 17) of two alignment posts (18, 19). The two fiducial surfaces (16, 17) are normal or substantially normal to the plane of the planar or substantially planar photonic circuit. The two fiducial surfaces (16, 17) are positioned at an appropriate distance (or appropriate respective distances) from the optically active portion (20) of an I/O port. FIG. 9 shows a cross-sectional view of the passive alignment fixture of FIG. 8, which fixture has been cut through plane IX-IX′ of FIG. 8. FIG. 9 further shows a suitable superstrate layer(s) (44), a suitable intermediate layer(s) (45) and a suitable substrate layer(s) (46) for a photonic I/O port of U.S. patent application Ser. No. ______, which was filed on Mar. 28, 2002. As shown in FIG. 9, vertical alignment of the optical fiber (13) (that is, alignment in the z direction) is achieved by contact of the optical fiber (13) with at least one additional point (48) on the superstrate layer(s) (44) of the photonic I/O port.

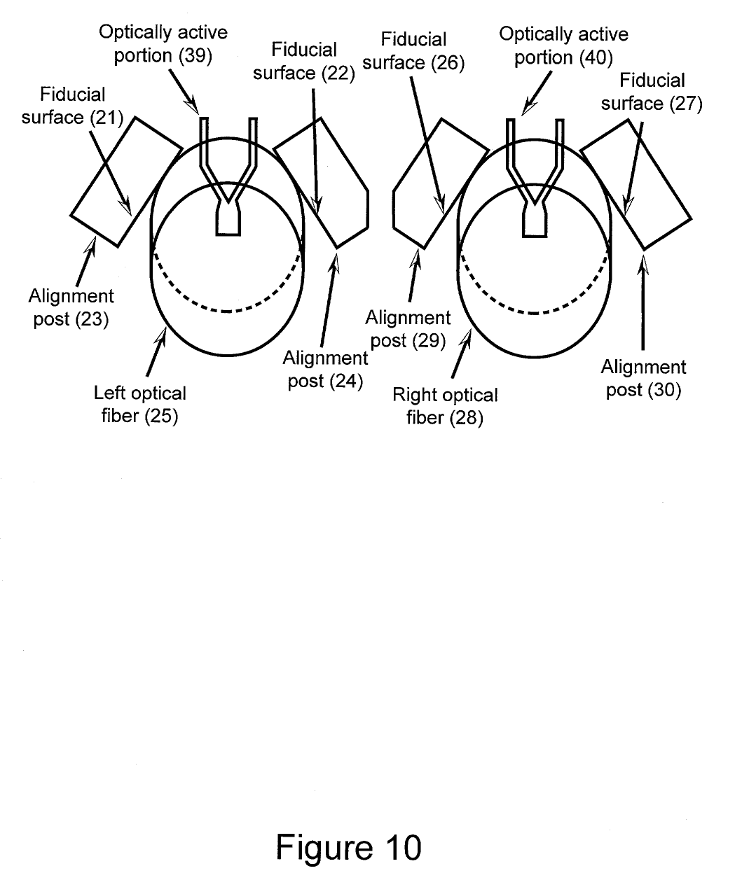

In another preferred embodiment of the present passive alignment fixtures, an optical fiber ribbon is connected to a series of I/O ports. An optical fiber ribbon comprises two or more optical fibers that may be spaced equally apart from one another. In this preferred embodiment, an optical fiber ribbon is oriented with the longitudinal axes of the optical fibers at near-normal angles to the plane of a planar or substantially planar photonic device. FIG. 10, for example, shows a plan view of an embodiment of the present passive alignment fixtures used with an optical ribbon (comprising two optical fibers) and two photonic I/O ports. Two planar or substantially planar fiducial surfaces (21, 22), which are formed by and are two planar or substantially planar surfaces on two alignment posts (23, 24), align the left optical (25) fiber with optically active portion (39) of a photonic I/O port. Two additional planar or substantially planar fiducial surfaces (26, 27), which may be otherwise the same as the two fiducial surfaces (21, 22), are formed by and are two planar or substantially planar surfaces of two alignment posts (29, 30). Those two fiducial surfaces (26, 27) align the right optical fiber (28) with optically active portion (40) of a photonic I/O port. As shown in FIG. 10, it may be advantageous, in certain applications, to alter the shape of the alignment posts (24, 29) (for example, to prevent or reduce mechanical obstructions). Alignment posts may therefore be of symmetrical shape (for example, square or rectangular), as depicted by alignment posts (23, 30), or alignment posts may be of a more complex or non-uniform shape, as, for example, depicted by alignment posts (24, 29).

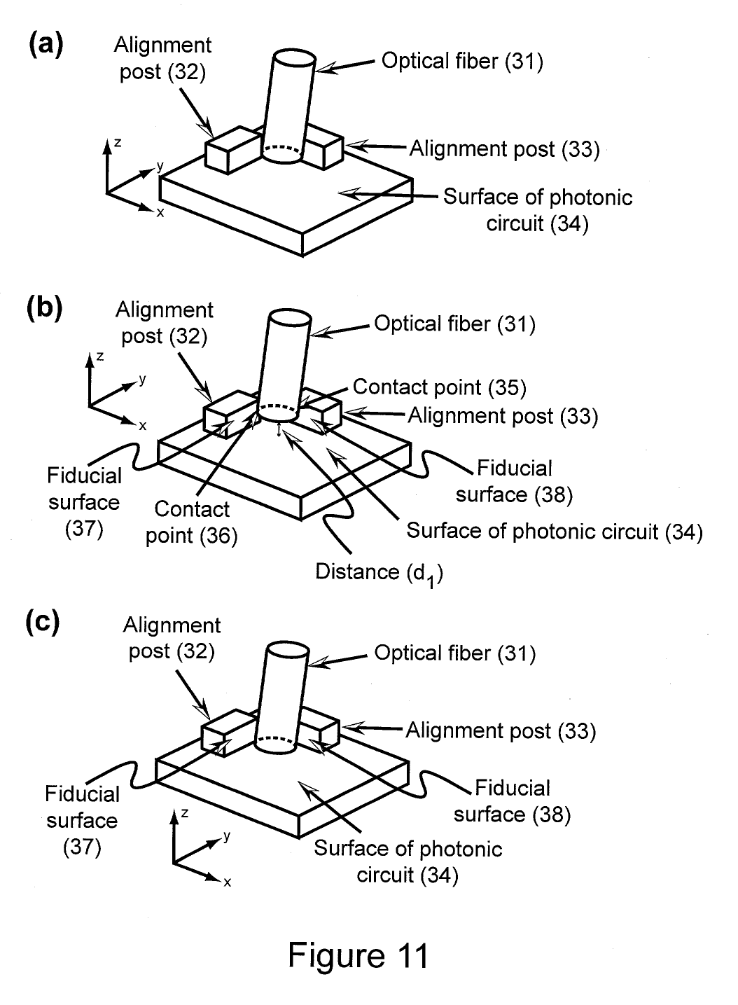

Preferred dimensions for alignment posts of the present passive alignment fixtures are a height of approximately 50 μm, a length of approximately 100 μm and a width of approximately 50 μm. Suitable dimensions for alignment posts of the present passive alignment fixtures include all dimensions that permit effective contact between an optical fiber and fiducial surfaces of the present passive alignment fixtures. The above-specified preferred dimensions should be compatible with automated alignment of the present passive alignment fixtures (for example, during an alignment process as shown in FIG. 11).

In the three-step alignment process shown in FIG. 11, an optical fiber (31) is initially positioned in proximity to two alignment posts (32, 33), but optical fiber (31) is not in contact with the alignment posts (32, 33) and not in contact with any part of a surface of a photonic circuit (34). In a second step, the optical fiber (31) is moved to an intermediate position, where it contacts at least two points (35, 36) on two planar or substantially planar fiducial surfaces (37, 38), which are formed by and are two planar or substantially planar surfaces of the two alignment posts (32, 33), and where the optical fiber (31) is at a distance (d₁) above the surface of the photonic circuit. Finally, while the contact between the optical fiber (31) and the two fiducial surfaces (37, 38) is maintained, the optical fiber (31) is further moved until the optical fiber (31) comes into sufficient contact with a desired part of the surface of the photonic circuit (34). Sufficient contact is contact that allows for acceptable overall performance of the photonic circuit. At this point, a suitable adhesive may be applied to the alignment posts (32, 33) to attach (that is, hold together) the entire structure, which comprises the alignment posts (32, 33), the optical fiber (31), and the surface of the photonic circuit (34). Alternatively, an adhesive may be applied to the alignment posts before the three-step process shown in FIG. 11.

In addition to the specific materials described above (for example, Si, and SiO₂), other materials may be suitable materials for the present passive alignment fixtures, depending, for example, on the particular application(s) at issue. For example, SiN (silicon nitride) may be a suitable material for the present passive alignment fixtures, and so too may be GaAs (that is, gallium arsenide) and InP (that is, indium phosphide).

Many additional modifications and variations of the present passive alignment fixtures are possible in light of the above teachings. Thus, it is to be understood that, within the scope of the appended claims, the present passive alignment fixtures may be practiced otherwise than as described hereinabove.

1. An optical fiber passive alignment fixture for a planar or substantially planar photonic circuit, comprising at least two planar or substantially planar fiducial surfaces that are normal or substantially normal to a plane of the planar or substantially planar photonic circuit.

2. The optical fiber passive alignment fixture of claim 1, further comprising an optical fiber, the longitudinal axis of which is near-normal to the plane of the planar or substantially planar photonic circuit, and which is positioned such that it has at least one contact point with each of the at least two planar or substantially planar fiducial surfaces.

3. The optical fiber passive alignment fixture of claim 1, wherein the at least two planar or substantially planar fiducial surfaces are formed by and are at least two planar or substantially planar surfaces of at least two alignment posts.

4. The optical fiber passive alignment fixture of claim 3, wherein the at least two alignment posts each have the same height of approximately 50 μm.

5. The optical fiber passive alignment fixture of claim 1, produced by a process comprising at least one micro-machining technique.

6. The optical fiber passive alignment fixture of claim 1, produced by a process comprising wafer bonding.

7. The optical fiber passive alignment fixture of claim 1, wherein the optical fiber passive alignment fixture comprises a material from the group consisting of: Si, SiO₂, SiN, GaAs and InP.

8. A process for aligning the optical fiber passive alignment fixture of claim 1 with an optical fiber, comprising the steps of
initially positioning the optical fiber in proximity to, but not in contact with, at least two alignment posts,
thereafter moving the optical fiber to an intermediate position, where the optical fiber contacts at least one point on each of the at least two fiducial surfaces, which are formed by and are at least two planar or substantially planar surfaces of the at least two alignment posts, and where the optical fiber is above the plane of the planar or substantially planar photonic circuit, and,
while the contact between the optical fiber and the at least two fiducial surfaces is maintained, further moving the optical fiber, until it comes into sufficient contact with a desired part of the surface of the planar or substantially planar photonic circuit.

9. The process of claim 8, further comprising the step of applying an adhesive to the at least two alignment posts to attach the at least two alignment posts, the optical fiber and the desired part of the surface of the planar or substantially planar photonic circuit.
